(19) United States
(12) Patent Application Publication
(10) Pub. No.: US 2023/0238636 A1
(43) Pub. Date: Jul. 27, 2023

(54) Electric Car Power Boaster System

(71) Applicant: Regnault Umaru Bamiji, Abuja (NG)

(72) Inventor: Regnault Umaru Bamiji, Abuja (NG)

(21) Appl. No.: 17/586,474

(22) Filed: Jan. 27, 2022

(51) Int. Cl. H01M 50/256; H01M 50/249

(52) U.S. Cl. CPC H01M 50/256; H01M 50/249

(57) ABSTRACT

An Electric car Power Boaster System, includes 12V Dynamo 4,Pulley 1, Belt 2, Pulley 3, DC-AC Inverter 6, 12V reservoir battery 5, 48 v Lithium battery charger 7 in symbiotic operation the with 48V lithium battery 8, 48V electric brush-less motor 9, Drive Unit 10, to form the Electric car Power Boaster system. When the car is driving, it spins the Dynamo 4, and the Dynamo connected to the DC reservoir 5 charges and store power until when needed. When the Lithium battery depleted during driving, the Inverter 6 and the 48V lithium battery charger 7 which are connected to the dc battery reservoir 5 is switch ON, this charges the depleted 48 v lithium battery fast enough, acting as a mobile charging station for another round of trip.

### TECHNICAL FIELD

A system for internally boasting Lithium battery power for electric cars to prolong drive,especially in situations where charging stations are not readily available, most current electric vehicles lithium batteries depletes when driving, and this depleted batteries needs to be charge at charging stations, unfortunately most times these batteries depleted in locations where there are no charging stations, making the electric car uninteresting and inconvenient. The New system uses a DC 12 v dynamo as original source of power generation, to supply charging voltage to DC reservoir, which is used to charge the lithium batteries supplying power to the electric car, when lithium battery goes flat or low.

### BACKGROUND

Electric cars are subject to intermittent charging of its lithium battery, after some period of driving the battery depletes,and will need another round of charge for its lithium batteries for another driving section, in most situation charging stations are not readily available, most especially in under developed Countries, Making the electric car and its technology of no importance or needed in such Countries.

Even in develop Countries where the charging station are available, there is the possibility of the batteries depleting in an area where such charging stations are not readily available, making the use of the electric car cumbersome and unnecessary.

It therefore becomes necessary to invent a system that will take care of this problems. The Electric car Power Boaster Charging was developed to handle this problems, the system takes in a little amount of energy via a dynamo that is connected to the wheel of the electric car, which generates charging voltage to charge the large DC reservoir and store the energy in a large DC reservoir, this stored energy will be use to charge the lithium batteries when it depletes. Now when the electric car battery depletes due to use, an inverter and A lithium battery charger which are already installed and connected to the DC reservoir, triggers ON to charges the lithium battery acting as a mobile charging station, the charging is so fast hence boasting the lithium batteries for another round of drive. This helps to prolong drive of the electric car, especially in locations where charging station are not available.

### SUMMARY

The Electric car Power boaster consists of 12 v Dynamo, which is powered by the spinning of the electric car wheels, which generates a charging voltage of 14.5 Vdc, The Charging current generated by the Dynamo is used to Charge a 12V Battery as reservoir. When the lithium batteries that power the electric car depletes due to use, an Inverter already installed and connected to the 12V DC Battery(the Reservoir) is switch ON, and it begins to inverts the DC 12V Reservoir to AC Voltage. The AC voltage is connected to a 48V lithium battery charger already installed in the system to generate a charging voltage of 58.8V to charge the lithium battery that supplies the electric motor that drives the electric car. This arrangement ensures charging voltage available in the DC battery reservoir to charge the depleted electric car lithium batteries for another round of trip.

The system ensures charging voltage is always available, with its original source been the spinning Dynamo. The friction of the dynamo and belt on the wheel of the electric car while driving is so negligible, unlike using normal alternators.This dynamo begins to generate charging voltage at a very minimal rpm, unlike using dc alternators that must spin at high speed and creates more friction to produce charging voltage.

### Brief Description of the several view of the drawing

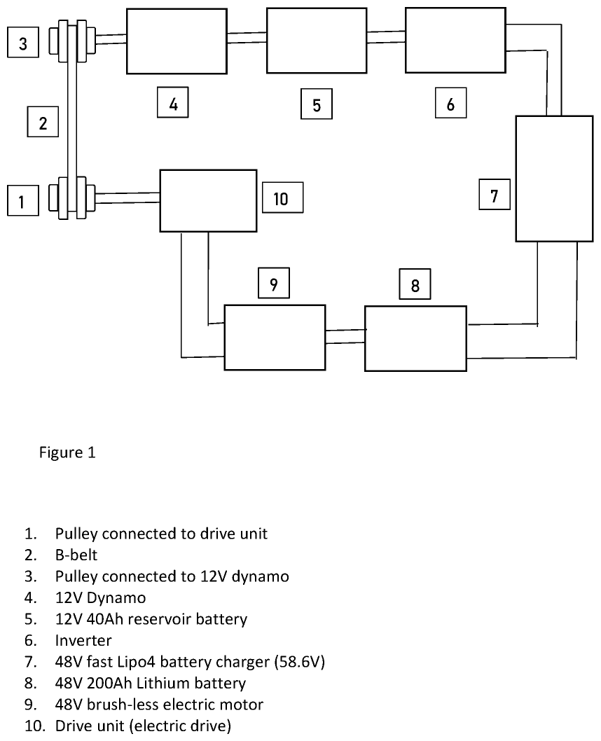

As illustrated in the drawing in FIG. 1. depicting the Electric Car Power Boaster system, when the dynamo (4) which is connected to the wheel of the electric car via belt (2) spins, it generate a charging voltage, this charging voltage is connected to a large reservoir battery (5), the reservoir battery(5) is always fully charge by the spinning of the Dynamo(4). A DC-AC inverter (6) is connected to the large DC reservoir battery (5) to invert the DC voltage to AC voltage. A lithium Battery charger (7) is connected to the inverter (6) to generate a AC-DC voltage of 58.6V to charge the electric car lithium battery(8) that supplies the electric car.

When there is a drop of voltage in the Lithium Battery(8) due to usage, and eventual power lost by the lithium batteries(8) and cannot drive the car any longer, This Electric car power boaster system is switch ON, and it begins to charge the lithium battery (8), this charging is very fast to fully charge the batteries for another round of driving. When the electric car starts driving again, the dynamo begins to spin to charge the large DC battery reservoir(5) for another round of power storage.

### DETAIL DESCRIPTION OF THE INVENTION

This invention relates to Electric Car Power Power Boaster charging system. The current models of electric cars are limited to charging stations and depletion of batteries when driving, this depleted batteries needs to be charged before driving the electric car again, and in most cases, charging stations are not available, and this could cause unnecessary discomfort and inconvenience , possibly towing the car to the next charging station, which might be kilometers away, aside the availability of this charging stations is one of the biggest problem that needs to be overcome and in most cases batteries may deplete in a places where there are no charging stations.

Worst of all, in third world countries where such charging stations are not readily available, it makes the electric cars technology uninteresting and absolutely impossible to drive electric cars in those regions. While in countries where this charging stations are available, there are cases of electric car batteries going flat in an disadvantage location without means of charging this batteries. All this disadvantages causes discomfort and necessary inconvenience to the driver and passengers, making the electric car undesirable, cumbersome and uninteresting.

To overcome this, the present invention proposes an Electric car Power Boaster system to prolong drive, that uses its reservoir DC power stored during drive to charge the depleted batteries extending drive time. This is made possible by installing an Electric car Power Boaster system in the electric car power system. The Electric car Power Boaster uses Dynamo at its input or source when the wheel of the electric car spins during driving. The Power generated by the Dynamo is stored in a large DC reservoir battery.

The Dynamo is so unique such that at 10 km/h speed of the car, it has already started charging, unlike the usual alternators for cars. This was indicated by the ‘Idiot light that goes off to indicate it is already supply charging current to the DC reservoir battery.

I have tried to replace this dynamo with the usual alternator for cars, but the car has to go at a higher speed with more friction before charging current is generated. Hence the uniqueness of this dynamo that makes it easy to charge the batteries at a low speed.

The charging system is designed in such a way that the Dynamo needs only minimum spinning of 200 rpm to start charging the large DC Reservoir battery which is used by the inverter and the 48V lithium battery charger to supplies 58.8V charging voltage to the lithium batteries, when it goes flat and could not drive the car again. The large DC reservoir battery always have power stored, when the car is driving. Hence it will always have the power to charge the Lithium batteries of the electric car, when the switch that connects it to the inverter and the lithium battery charge is switch ON.

The Dynamo, the pulleys, the belt, the 12V Reservoir battery, the Inverter, the 48 v lithium battery charger work in symbiosis with the 48V lithium batteries, the 48 v brush-less motor,and the drive unit to form a complete unit of the Electric Car Power Boaster system. Hence this components working together in symbiotic cycles supports each other, and maintaining an almost full battery voltage for the reservoir battery, making the charging unit acts as a mobile charging station for the electric car.

The invention will now be described sorely by way of example and with reference to the accompanying drawings in which:

FIG. 1. show the Dynamo 4 connected to spinning wheel of the electric car via a pulley 3 and belt 2, and Pulley1, it is further connected to the the 12 v battery reservoir 5 and to DC-AC inverter 6, which is connected to the 48 v Lithium battery charger 7 and to the 48V lithium batteries 8 to provide charging voltage. The 48V lithium batteries 8 supply Power the brush-less Motor 9 which powers the Drive Unit 10, forming the complete unit of the electric car Power Boaster system.

The Electric car Power Boaster system, is a very unique system, making power available all the time, because the voltage generated by the Dynamo 4 is stored in the reservoir battery 5, which will be use next to charge the depleted lithium batteries of the electric car.

The Dynamo 4, the Pulley 3, the Belt 2, Pulleyl, the 12 v Reservoir battery 5, the inverter 6, 48V lithium battery charger 7, forms the electric car Power boaster in cooperation with the the 48V Lithium battery 8, the 48 v brush less Motor 9, and the Drive unit 10 of the Electric car

The intelligent 48V lithium battery charger 7, is so unique, when there is drop of voltage that supplies the electric car Drive Unit 10 , it triggers the inverter 6 to connect with the reservoir battery 5, which in turn provide charging voltage to the 48 v lithium battery 8, via the 48V lithium battery charger 7, this process ensures that the 48V lithium battery are fully charge within a short time, for another round of trip.

Since the Dynamo 4 is always spinning been connected to the wheel of the electric car, power is always available from the Dynamo 4 to charge the Reservoir Battery 5. the Dynamo 4 supplies charging voltage to the Reservoir battery 5 at the lowest speed of 10 km/h or at 200 rpm.

The Reservoir battery 5, uses its stored voltage to charge the 48V Lithium battery 8, when the car is parked and the Dynamo no spinning.

1. Electric car Power Boaster System—that comprises of Drive belt, Pulleys, 12V Dynamo, 12 v Reservoir battery, inverter, 48 v lithium battery charger in symbiotic operation with the 48 v brush-less motor , 48 v Lithium batteries and the drive unit to form the boaster charging system for electric vehicles, that charges the depleted lithium battery, when charging stations are not readily available.

2. Electric Car Power Boaster system, according to claim 1, when the car is driving, the wheel of the car spins the dynamo, via a pulley and belt, it generates a charging voltage to charge the Dc Reservoir battery, and store the energy until needed to charge the depleted lithium batteries of the electric car.

3. Electric Car Power Boaster system , according to claim 2, when the voltage of the lithium battery that drives the electric car goes flat during drive, the inverter and the Lithium battery charger connected to the DC reservoir is switch ON, this charges the depleted Lithium battery of the electric car from the DC battery reservoir, acting as mobile charging station, for another round of trip.
